(19) United States
(12) Patent Application Publication
(10) Pub. No.: US 2025/0380061 A1
(43) Pub. Date: Dec. 11, 2025

(54) IMAGE SENSOR, IMAGE PROCESSING SYSTEM INCLUDING THE SAME AND IMAGE PROCESSING METHOD THEREOF

(71) Applicant: SAMSUNG ELECTRONICS CO., LTD., Suwon-si (KR)

(72) Inventors: Dongpan LIM, Suwon-si (KR); Jeongguk Lee, Suwon-si (KR)

(73) Assignee: SAMSUNG ELECTRONICS CO., LTD., Suwon-si (KR)

(21) Appl. No.: 18/988,075

(22) Filed: Dec. 19, 2024

(30) Foreign Application Priority Data
Jun. 10, 2024 (KR) 10-2024-0074721

(51) Int. Cl. H04N 25/13; H04N 25/78

(52) U.S. Cl. CPC H04N 25/134; H04N 25/78

(57) ABSTRACT

An image sensor includes a pixel array including a plurality of unit pixels configured to receive light of a color filter array having a first color pattern of size k×l arranged therein, where k and l are natural numbers of 3 or more, the image sensor configured to generate first image data including the first color pattern and an image signal processor (ISP) configured to generate second image data including a second color pattern of size p×q, by remosaicing the first image data, where p and q are natural numbers of 2 or more, where a size of the second color pattern is smaller than a size of the first color pattern, and the image sensor is configured to transmit the second image data an application processor that is external to the image sensor.

### CROSS-REFERENCE TO RELATED APPLICATION

This application is based on and claims priority to Korean Patent Application No. 10-2024-0074721, filed on Jun. 10, 2024, in the Korean Intellectual Property Office, the disclosure of which is incorporated by reference herein in its entirety.

### BACKGROUND

Example embodiments of the disclosure relate to an image sensor configured to perform a remosaic operation, an image processing system including the same, and an image processing method thereof.

In recent years, as the computer industry and the communication industry develop, there are increasing demands for the image sensors with improved performance in various fields, such as digital cameras, camcorders, smartphones, game devices, security cameras, medical micro cameras, robots, etc.

In particular, as the demands for electronic devices that can capture high-magnification or high-resolution images increase, resources required for image processing using image sensors also increase. Therefore, introduction of the image sensors or image processing systems that can reduce resources for image processing using the image sensors is required.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide an image sensor, an image processing system including the same, and an image processing method thereof.

Additional aspects will be set forth in part in the description which follows and, in part, will be apparent from the description, or may be learned by practice of the presented embodiments.

According to an aspect of an example embodiment, an image sensor may include a pixel array including a plurality of unit pixels configured to receive light of a color filter array having a first color pattern of size k×l arranged therein, where k and l are natural numbers of 3 or more, the image sensor configured to generate first image data including the first color pattern and an image signal processor (ISP) configured to generate second image data including a second color pattern of size p×q, by remosaicing the first image data, where p and q are natural numbers of 2 or more, where a size of the second color pattern is smaller than a size of the first color pattern, and the image sensor is configured to transmit the second image data an application processor that is external to the image sensor.

According to an aspect of an example embodiment, an image processing system may include an image sensor including a pixel array comprising a plurality of unit pixels configured to receive light of a color filter array having a first color pattern of size k×l arranged therein, where k and l are natural numbers of 3 or more, the image sensor configured to generate first image data including the first color pattern, and an ISP configured to generate second image data including a second color pattern of size p×q, by remosaicing the first image data, where p and q are natural numbers of 2 or more, and an image processing device external to the image sensor and configured to generate third image data by remosaicing the second image data.

According to an aspect of an example embodiment, an image processing method may include generating, by an image sensor, first image data including a first color pattern, based on an output signal of a pixel array configured to receive light of a color filter array having the first color pattern of size k×l arranged therein, where k and l are natural numbers of 3 or more, generating, by the image sensor, second image data including a second color pattern of size p×q by remosaicing the first image data, where p and q are natural numbers of 2 or more, and generating, by an application processor that is external to the image sensor, third image data by remosaicing the second image data.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a block diagram illustrating an example of an image processing system according to one or more example embodiments;

FIG. 2 is a block diagram illustrating a detailed configuration of an image sensor according to one or more example embodiments;

FIG. 3 is a diagram illustrating a detailed structure of a pixel array according to one or more example embodiments;

FIG. 4 is a diagram illustrating an example of the remosaic operation performed by an image sensor and an image processing device according to one or more example embodiments;

FIG. 5 is a diagram illustrating an example of remosaicing image data including a pattern of size 4×4 according to one or more example embodiments;

FIGS. 6 and 7 are diagrams illustrating a remosaic process in detail, according to one or more example embodiments;

FIG. 8 is a diagram illustrating an example of remosaicing image data including a pattern of size 3×3 according to one or more example embodiments;

FIGS. 9A, 9B, 10A and 10B are diagrams illustrating a remosaic process in detail according to one or more example embodiments;

FIG. 11 is a diagram illustrating an example of remosaicing image data including a pattern of size 2×2 according to one or more example embodiments;

FIG. 12 is a block diagram of an image processing system including an image sensor according to one or more example embodiments; and

FIG. 13 is a flowchart illustrating an image processing method according to one or more example embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

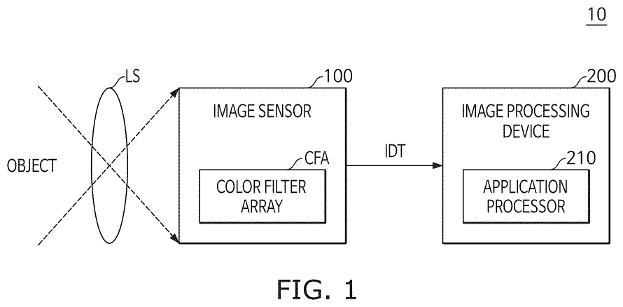

FIG. 1 is a block diagram illustrating an example of an image processing system 10 according to one or more example embodiments.

The image processing system 10 may be implemented as an electronic device that captures an image, displays the captured image, or performs an operation based on the captured image. For example, the image processing system 10 may be implemented with a personal computer (PC), an Internet of Things (IoT) device, or a portable electronic device. The portable electronic device may include a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a portable game console, an e-book, a wearable device, etc. In addition, the image processing system 10 may be mounted on electronic devices such as drones and advanced drivers assistance systems (ADAS) or electronic devices provided as components in vehicles, furniture, manufacturing facilities, doors, or various measuring devices.

Referring to FIG. 1, the image processing system 10 may include an image sensor 100 and an image processing device 200. The image processing system 10 may further include other components such as a display, a user interface, etc. The image processing device 200 may include an application processor 210. The image processing device 200 or the image processing system 10 may be implemented as a system on chip (SoC).

The image sensor 100 may convert an optical signal reflected off from an object through an optical lens LS into an electrical signal, generate image data IDT based on the electrical signal, and output the same. The image sensor 100 may include a color filter array CFA having a predetermined color pattern, and may convert the optical signal into an electrical signal by using the color filter array CFA.

The color filter array CFA may include a plurality of color filters (e.g., a red color filter, a blue color filter, a green color filter, etc.) provided to correspond to each of a plurality of unit pixels in the image sensor 100. In one or more embodiments, reflecting human visual characteristics, the red color filter may occupy 25% of the color filter array CFA, the blue color filter may occupy 25%, and the green color filter may occupy 50%. The red color filter, the blue color filter, the green color filter, and a ratio between these color filters are merely an example, and embodiments are not limited thereto. For example, in one or more embodiments, color filters based on various types of filters, such as cyan filters, RGBW filters, etc., may be applicable and the embodiments are not limited to a specific color sensing pattern.

In the color filter array CFA, a plurality of color filters of the same color may be arranged adjacent to each other. The color filter array CFA may include a specific color pattern according to arrangement of the plurality of color filters. For example, k (where k is a natural number) number of color filters of the same color may be arranged adjacent to each other in a first direction of two-dimensional plane, and l (where l is a natural number) number of color filters may be arranged in a second direction perpendicular to the first direction. A repeating pattern of this arrangement may be referred to as a color pattern of size k×l. For example, k and l may be natural numbers of 2 or more.

In one or more embodiments, the color filter array CFA may include a color pattern of size 4×4 in which 16 color filters of the same color are arranged adjacent to each other in 4×4 form. The color pattern of size 4×4 may refer to a pattern in which 16 color filters of a specific color are arranged in 4×4 form, and 16 color filters of other colors arranged adjacent to each other in 4×4 form are disposed on the top, bottom, left, and right sides with respect to the 16 color filters of the specific color.

In one or more embodiments, the color filter array CFA may include a color pattern of size 3×3 in which 9 color filters of the same color are arranged adjacent to each other in 3×3 form. The color pattern of size 3×3 may refer to a pattern in which 9 color filters of a specific color are arranged in 3×3 form, and 9 color filters of other colors arranged adjacent to each other in 3×3 form are disposed on the top, bottom, left, and right sides with respect to the 9 color filters of the specific color.

In one or more embodiments, the color filter array CFA may include a color pattern of size 2×2 in which 4 color filters of the same color are arranged adjacent to each other in 2×2 form. The color pattern of size 2×2 may refer to a pattern in which 4 color filters of a specific color are arranged in 2×2 form, and 4 color filters of other colors arranged adjacent to each other in 2×2 form are disposed on the top, bottom, left, and right sides with respect to the 4 color filters of the specific color.

The image processing device 200 (or, the application processor 210 or an image signal processor (ISP) in the application processor 210) may reduce noise on the image data IDT and perform image signal processing to improve image quality, such as gamma correction, color filter array interpolation, color matrix, color correction, color enhancement, etc. In addition, the image processing device 200 may generate image files by compressing image data which is generated by the image signal processing to improve image quality, or restore image data from the image files.

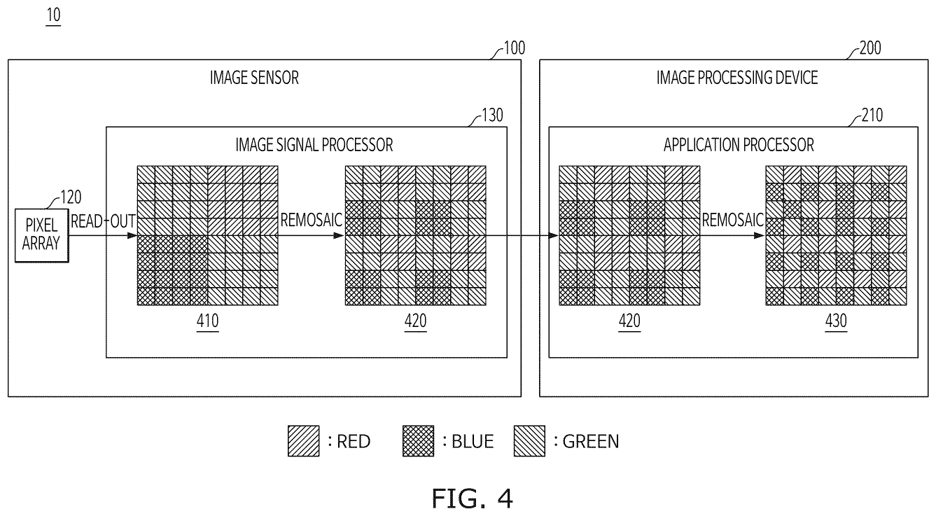

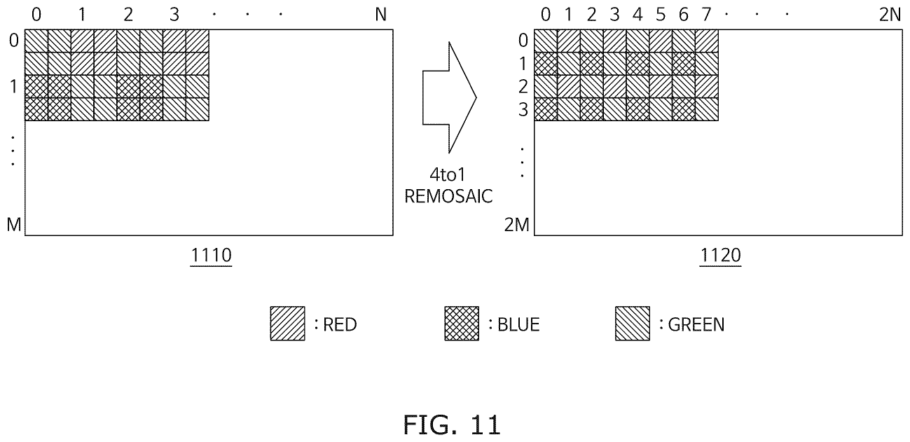

The application processor 210 (or, the ISP in the application processor 210) of the image processing device 200 may perform image processing including remosaic and/or demosaic operation on the image data IDT received from the image sensor 100. The application processor 210 (or, the ISP) may additionally perform the remosaic operation on the image data IDT that has been remosaiced in the image sensor 100. The remosaic operation performed by the application processor 210 (or, the ISP) will be described below in detail with reference to FIGS. 4 and 11.

The application processor 210 (or, the ISP) may perform image processing to convert a format of the image data IDT. The application processor 210 may convert the image data IDT corresponding to a specific color pattern into full-color image data in RGB format.

In addition to the operation of converting the format of the image data IDT into full image data, the image processing device 200 may perform pre-processing such as crosstalk correction and a despeckle operation on the image data IDT, and may further perform post-processing such as a sharpening operation on the full image data. The image processing device 200 may further perform operations such as auto dark level compensation (ADLC), bad pixel correction, lens shading correction, etc., on the image data IDT.

Additionally or alternatively, the operations of the image processing device 200 or the application processor 210 described above may be performed on the image data generated by performing the remosaic operation on the image data IDT in the application processor 210 (or, the ISP).

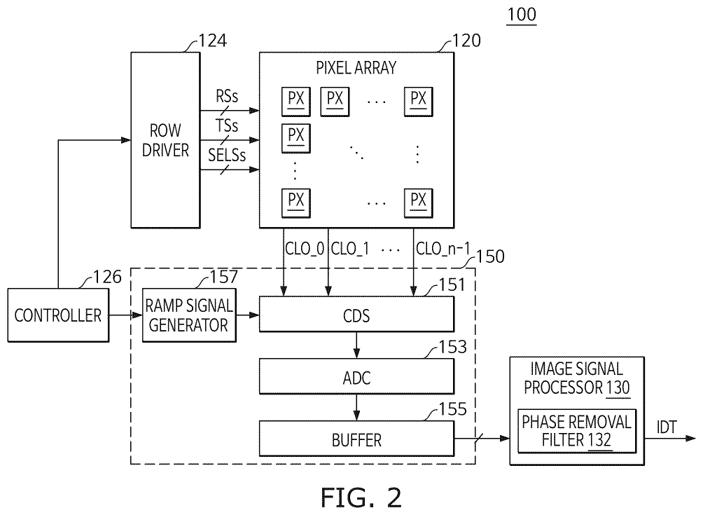

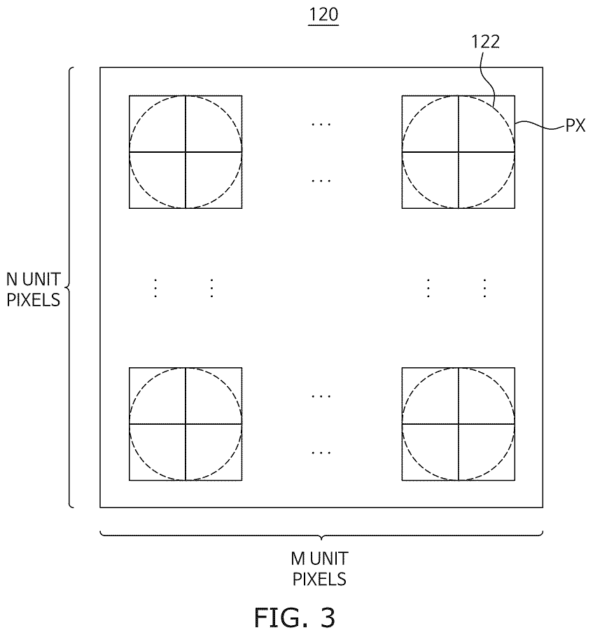

FIG. 2 is a block diagram illustrating a detailed configuration of an image sensor according to one or more example embodiments. FIG. 3 is a diagram illustrating a detailed structure of a pixel array according to one or more example embodiments. That is, FIG. 2 is a block diagram illustrating a detailed configuration of the image sensor 100 of FIG. 1, and FIG. 3 is a diagram illustrating a detailed structure of a pixel array 120 of FIG. 2.

Referring to FIG. 2, the image sensor 100 may include the pixel array 120, a controller 126, an ISP (ISP) 130, a row driver 124, and a signal reader 150. The signal reader 150 may include a correlated-double sampling (CDS) 151, an analog-digital converter (ADC) 153, a buffer 155, and a ramp signal generator 157.

The pixel array 120 may be configured to convert an optical signal into an electrical signal and include a plurality of unit pixels PX arranged two-dimensionally (e.g., in a two-dimensional array form). In one or more embodiments, the pixel array 120 may be configured with N (where Nis a natural number of 1 or more) number of unit pixels PX arranged in a vertical direction, and M (where M is a natural number of 1 or more) number of unit pixels PX arranged in a horizontal direction. The resolution of the image generated by the image sensor 100 may vary according to the number of unit pixels PX. For example, the pixel array 120 may include 4,000 unit pixels PX arranged in the horizontal direction, and 3,000 unit pixels PX arranged in the vertical direction. In this case, the pixel array 120 may generate an image with a resolution of 12 megapixels (Mp) (4,000×3,000). In another example, the pixel array 120 may include 8,000 unit pixels PX arranged in the horizontal direction, and 6,000 unit pixels PX arranged in the vertical direction. In this case, the pixel array 120 may generate an image with a resolution of 48 Mp (8,000×6,000).

The color filter array CFA illustrated and described with reference to FIG. 1 may be disposed in the pixel array 120, and the pixel array 120 may receive transmitted light through the color filter array. That is, each of the plurality of unit pixels PX may sense a color corresponding to a color filter disposed on each of a plurality of corresponding unit pixels PX. Although it is described herein that the color filter array CFA is disposed in the pixel array 120, embodiments are not limited hereto, and the color filter array CFA may be included in the pixel array 120.

Each of the plurality of unit pixels PX may generate pixel signals according to the intensity of the sensed light (e.g., transmitted light through the color filter array CFA). For example, the unit pixel PX may be implemented as a photoelectric conversion element such as a charge coupled device (CCD), a complementary metal oxide semiconductor (CMOS), etc., and may also be implemented as various other types of photoelectric conversion devices.

Referring to FIGS. 2 and 3, a microlens 122 may be disposed in the pixel array 120 for every arbitrary number of (e.g., two, four) unit pixels PX. The image sensor 100 may use the microlens 122 to sense the phase difference of light according to a position on the pixel array 120. The image sensor 100 may change the sensed phase or the sensed phase difference of light into a digital form of phase data and output the phase data to the image processing device (e.g., 200 of FIG. 1). For example, the phase data may be included in the image data IDT output from the ISP 130.

The controller 126 may control the row driver 124 such that the pixel array 120 absorbs light to accumulate electrical charges, temporarily stores the accumulated electrical charges, and outputs an electrical signal according to the stored electrical charges to the external to of the pixel array 120. The row driver 124 may generate signals RSs, TSs, and SELSs for controlling the pixel array 120 and provide the signals to the plurality of unit pixels PX. The row driver 124 may determine activation and deactivation timing of the reset control signals RSs, the transmission control signals TSs, and the selection signals SELSs provided to the unit pixels PX.

The controller 126 may control the signal reader 150 to measure a level of the pixel signals provided by the pixel array 120. Each of the plurality of unit pixels PX may output pixel signals to the CDS 151 through the corresponding first to n-th column output lines CLO_0 to CLO_n-1, and the CDS 151 may sample and hold the pixel signals provided by the pixel array 120. The CDS 151 may doubly sample a specific level of noise and a level according to the pixel signals, and output a level corresponding to the difference. In addition, the CDS 151 may receive ramp signals generated by the ramp signal generator 157 and compare the ramp signals with each other to output a comparison result.

The analog-digital converter 153 may convert an analog signal corresponding to the level received from the CDS 151 into a digital signal. The buffer 155 may latch the digital signal, and the latched digital signal may be sequentially output as the image data IDT to the external to of the ISP 130 or the image sensor 100. The latched digital signal may include pixel values corresponding to the plurality of unit pixels PX of the pixel array 120, and each of the plurality of pixel values may be proportional to an amount of light received by the corresponding unit pixel.

The ISP 130 may perform signal processing based on the received pixel signals (or, pixel values) output from the plurality of unit pixels PX. For example, the ISP 130 may perform noise reduction, gain adjustment, waveform shaping, interpolation, white balance, gamma correction, edge emphasis (or, enhancement), etc.

The ISP 130 may include a phase removal filter 132. The phase removal filter 132 may be implemented in hardware and/or software. The phase removal filter 132 may remove phase data generated by using the microlens 122. The ISP 130 may perform the remosaic operation using data from which phase data is removed through the phase removal filter 132.

The ISP 130 may perform the remosaic operation on the image data generated based on the output signals of the pixel array 120. The remosaic operation performed by the ISP 130 will be described below in detail with reference to FIGS. 4 to 10.

FIG. 4 is a diagram illustrating an example of a remosaic operation performed by the image sensor 100 and the image processing device 200, according to one or more embodiments. The image sensor 100 may generate first image data 410 based on the output signals of the pixel array 120 (or, of the signal reader 150 of FIG. 2). The first image data 410 may include a plurality of pixel values output using the pixel array 120.

The first image data 410 may include color data representing a color corresponding to each of a plurality of pixel values of the color pattern of size k×l (where k is a natural number of 3 or more, and l is a natural number of 3 or more) of the color filter array CFA in the image sensor 100. The first image data 410 may be generated by the pixel array 120 sensing the transmitted light of the color filter array CFA, and may include the same color pattern as the color pattern of size k×l of the color filter array CFA. That is, by physically arranging the color pattern of size k×l in the color filter array CFA disposed on the pixel array 120, the first image data 410 including a color pattern having the same size and arrangement may be generated.

The ISP 130 of the image sensor 100 may perform the remosaic operation on the first image data 410 including the color pattern of size k×l so as to generate second image data 420 including a color pattern of size p×q (where p is a natural number of 2 or more, and q is a natural number of 2 or more). The second image data 420 may include a color pattern of a size smaller than that of the first color pattern of the first image data 410.

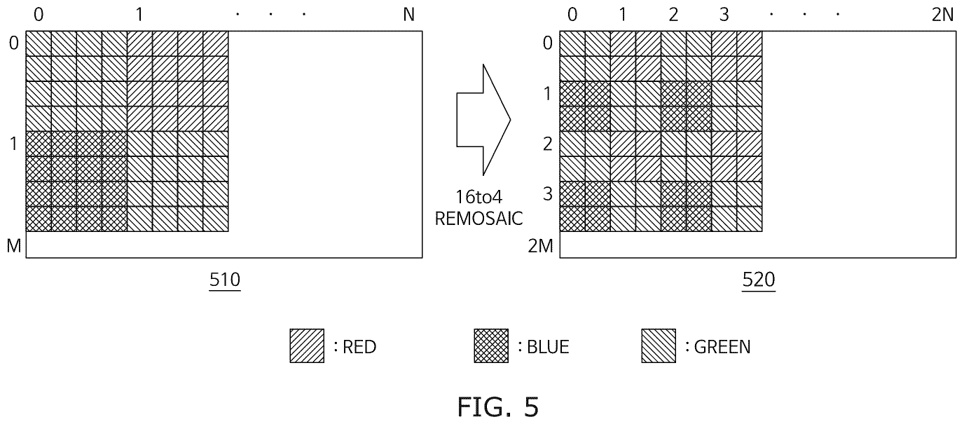

For example, as illustrated in FIG. 4, the ISP 130 may perform remosaicing on the first image data 410 including the color pattern of size 4×4 to generate the second image data 420 including the color pattern of size 2×2. An example of a process of generating the second image data 420 including the color pattern of size 2×2 from the first image data 410 including the color pattern of size 4×4 will be described below in detail with reference to FIGS. 5 to 7.

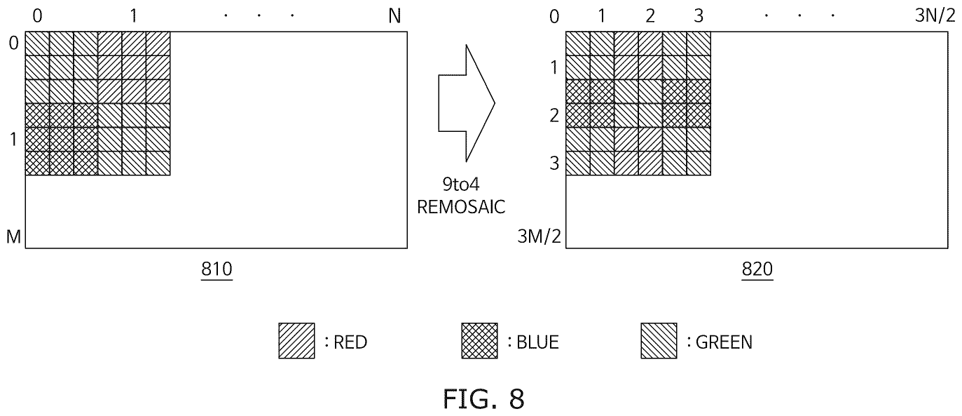

The ISP 130 may perform remosaicing on the first image data 410 including the color pattern of size 3×3 to generate the second image data 420 including the color pattern of size 2×2. An example of a process of generating the second image data 420 including the color pattern of size 2×2 from the first image data 410 including the color pattern of size 3×3 will be described below in detail with reference to FIGS. 8 to 10.

The second image data 420 including the color pattern of size p×q may be transmitted from the ISP 130 of the image sensor 100 to the image processing device 200 (e.g., a device that is external to the image sensor 100). The application processor 210 of the image processing device 200 may include an ISP. The application processor 210 of the image processing device 200 (or, the ISP of the application processor 210) may perform the remosaic operation on the received second image data 420 to generate third image data 430 including a color pattern of size (p/2)× (q/2) (where p and q are even numbers). For example, the third image data 430 may include a single Bayer pattern as illustrated in FIG. 4. An example in which the third image data 430 is generated will be described below in detail with reference to FIG. 11.

In other words, a plurality of remosaic operations on the first image data 410 may be divided and performed in each of the ISP 130 of the image sensor 100 and the application processor 210 of the image processing device 200. Accordingly, resources used for performing the remosaic operation in the image sensor 100 may be reduced, and image processing may be efficiently performed. In addition, an ordinarily complex structure of the ISP 130 or the image sensor 100 may be simplified because the ISP 130 may not be required to include every logic component corresponding to various types of remosaic operations (e.g., operations of remosaicing a color pattern of size 4×4 into a Bayer pattern, operations of remosaicing a color pattern of size 2×2 into a Bayer pattern, etc.).

Additionally, the application processor 210 of the image processing device 200 may demosaic the third image data 430 to generate a demosaiced image. The generated demosaiced image may be included in the image processing system 10 or may be displayed through a user interface associated with it.

FIGS. 5 to 11 are diagrams illustrating an example of a process of remosaicing the image data according to one or more embodiments. The image data illustrated and described with reference to FIGS. 5 to 11 may include a plurality of pixel values sensed or converted from a plurality of unit pixels of a pixel array (e.g., the pixel array 120 of FIGS. 1 to 3), and may include color data associated with a color represented by each of the plurality of pixel values. For example, the color data may be included in the pixel value.

For convenience of explanation, the image data illustrated in FIGS. 5 to 11 is a visualization of a plurality of pixel values and color data included in the image data. Although the image data in FIGS. 5 to 11 are illustrated to represent the same pixel values for the same color, this is for convenience of explanation, and embodiments are not limited hereto. That is, a pixel value in the image data may have any value sensed from the unit pixel.

The remosaic operation illustrated and described with reference to FIGS. 5 to 10 may be performed by the image sensor 100 (or, the ISP 130 in the image sensor 100), and the remosaic operation illustrated and described with reference to FIG. 11 may be performed by an application processor 210 external to the image sensor 100 (e.g., in an image processing device 200 that is external to (separate from) the image sensor 100).

FIG. 5 is a diagram illustrating an example of remosaicing image data including a pattern of size 4×4 according to one or more embodiments. First image data 510 to be remosaiced may correspond to the first image data 410 of FIG. 4, and second image data 520 may correspond to the second image data 420 of FIG. 4.

As illustrated in FIG. 5, the first image data 510 may include a first color pattern of size 4×4, and image units of size 4×4 in a N×M arrangement (where N and M are both natural and even numbers). Remosaicing the first image data 510 may result in generation of the second image data 520 that includes a second color pattern of size 2×2, and a 2×2 sized image unit that can be arranged in a 2N×2M arrangement.

The second image data 520 may be transmitted to an external image processing device (e.g., the image processing device 200 of FIGS. 1 to 4) external to the image sensor where the remosaic operation of FIG. 5 is performed, and the remosaic operation may be further performed by the application processor (e.g., application processor 210 of FIGS. 1 to 4) of the image processing device.

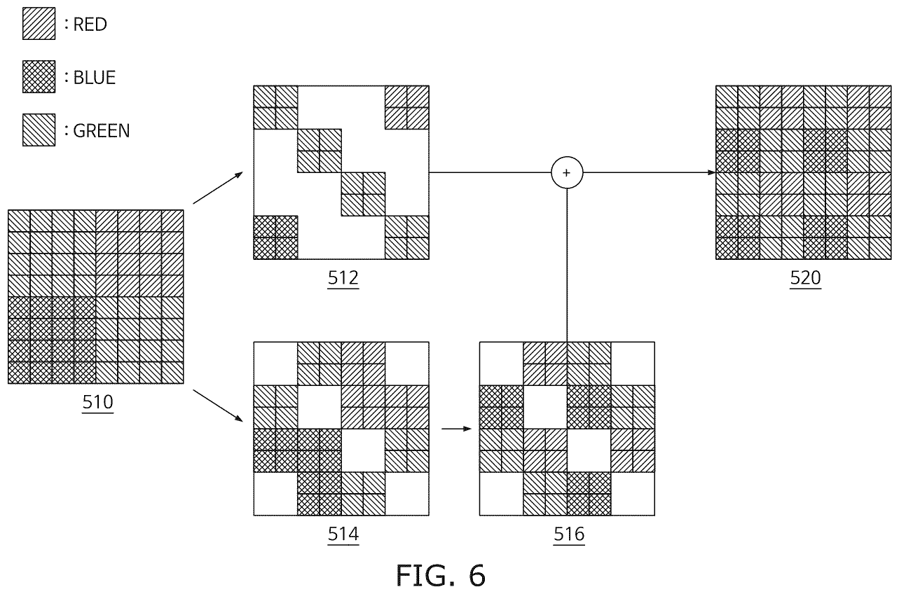

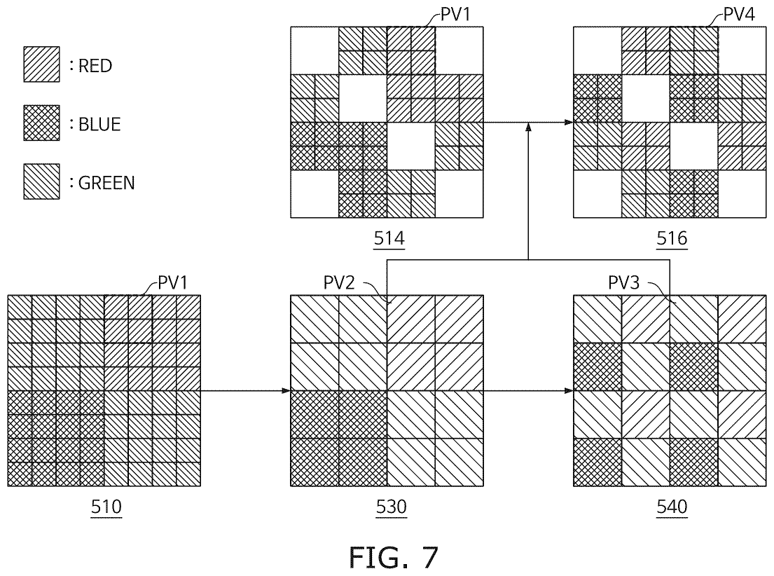

FIGS. 6 and 7 are diagrams illustrating a remosaic process in detail, according to one or more example embodiments. That is, FIGS. 6 and 7 are diagrams illustrating the remosaic process of FIG. 5 in detail. For convenience of explanation, only a part of the image data representing the color pattern is illustrated in FIGS. 6 and 7.

The first image data 510 including the first color pattern may be divided into first sub-image data 512 including pixel values read from a first group of unit pixels among the plurality of unit pixels, and second sub-image data 514 including pixel values read from a second group of unit pixels which correspond to the remaining unit pixels that are not included in the first group of unit pixels. The first sub-image data 512 and the second sub-image data 514 may be divided and processed separately. On the other hand, the first sub-image data 512 and the second sub-image data 514 are only illustrated to be divided from each other for convenience of explanation, and may be processed as the first image data 510 together without being divided from each other.

The second image data 520 including the second color pattern may be generated by retaining some of the pixel values included in the first image data 510 and changing the others.

For example, the pixel values of the first sub-image data 512 may be retained. The color corresponding to the first group of unit pixels included in the first color pattern of the first image data 510 may be the same as the color corresponding to the first group of unit pixels included in the second color pattern of the second image data 520. That is, the pixel values at positions representing the same color before and after remosaicing may be retained as they are.

On the other hand, the pixel values of the second sub-image data 514 may be changed. The color corresponding to the second group of unit pixels included in the first color pattern may be different from the color corresponding to the second group of unit pixels included in the second color pattern. That is, the pixel values at positions representing different colors before and after the remosaic may be changed.

The second image data 520 may include the first sub-image data 512, and third sub-image data 516 generated by changing the pixel values of the second sub-image data 514.

Referring to FIG. 7, in order to change the pixel values of the second sub-image data 514, the first image data 510 may be binned and reference image data 530 may be generated. A reference pixel value PV2 of the reference image data 530 may be an average value of a plurality of pixel values PV1 of the corresponding first image data 510. The first image data 510 may include a color pattern of size 4×4, and the reference image data 530 may include a color pattern of size 2×2. That is, if the first image data 510 includes a color pattern of size k×l (where k is a natural number of 3 or more, and l is a natural number of 3 or more), the color pattern of the reference image data 530 may be a pattern of size k/2×l/2 (where k is an even number, and l is an even number).

Target image data 540 may be generated as a result of remosaicing the reference image data 530. For example, referring to FIG. 7, the target image data 540 may include a Bayer pattern.

The plurality of pixel values PV1 of the second sub-image data 514 may be changed into a plurality of pixel values PV4 of the third sub-image data 516 based on the corresponding reference pixel value PV2 included in the reference image data 530 and on the corresponding target pixel value PV3 included in the target image data 540.

In one or more embodiments, the plurality of pixel values PV1 of the second sub-image data 514 may be changed into the plurality of pixel values PV4 of the third sub-image data 516 based on a ratio of the target pixel value PV3 to the reference pixel value PV2.

Additionally or alternatively, the plurality of pixel values PV1 of the second sub-image data 514 may be changed into the plurality of pixel values PV4 of the third sub-image data 516 based on an offset between the reference pixel value PV2 and the target pixel value PV3.

In one or more embodiments, the plurality of pixel values PV1 of the second sub-image data 514 may be changed into the plurality of pixel values PV4 of the third sub-image data 516 based on a weighted sum of the ratio of the target pixel value PV3 to the reference pixel value PV2 and the offset between the reference pixel value PV2 and the target pixel value PV3.

In other words, the plurality of pixel values PV1 of the second sub-image data 514 may be changed into the plurality of pixel values PV4 of the third sub-image data 516 based on Equation (1) below.

$$P V 4 = α * \frac{P V 3}{P V 2} * P V 1 + ( 1 - α ) * ( P V 3 - P V 2 + P V 1 ) \qquad ( 1 )$$

In Equation (1), a may be a real number greater than or equal to 0 and less than or equal to 1.

Through the process described above, the remosaic operation of converting a 4×4 color pattern into a 2×2 color pattern may be performed based on a value acquired in the remosaic process of converting the reference image data 530 having a 2×2 color pattern into the target image data 540 having a Bayer pattern.

FIG. 8 is a diagram illustrating an example of remosaicing image data including a pattern of size 3×3 according to one or more embodiments. First image data 810 to be remosaiced may correspond to the first image data 410 of FIG. 4, and second image data 820 may correspond to the second image data 420 of FIG. 4.

As illustrated in FIG. 8, the first image data 810 may include a first color pattern of size 3×3, and image units of size 3×3 in a N×M arrangement (where N and M are both natural and even numbers). Remosaicing the first image data 810 may result in the generation of the second image data 820 that includes a second color pattern of size 2×2, and image units of size 2×2 in a (3N/2)×(3M/2) arrangement.

The second image data 820 may be transmitted to an application processor external to the image sensor where the remosaic operation of FIG. 8 is performed, and the remosaic operation may be further performed in the application processor.

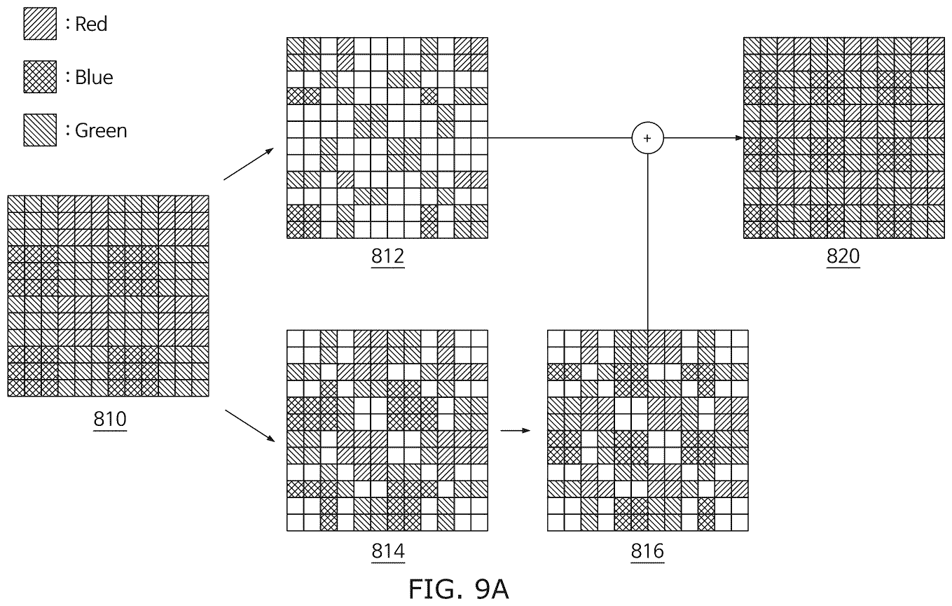

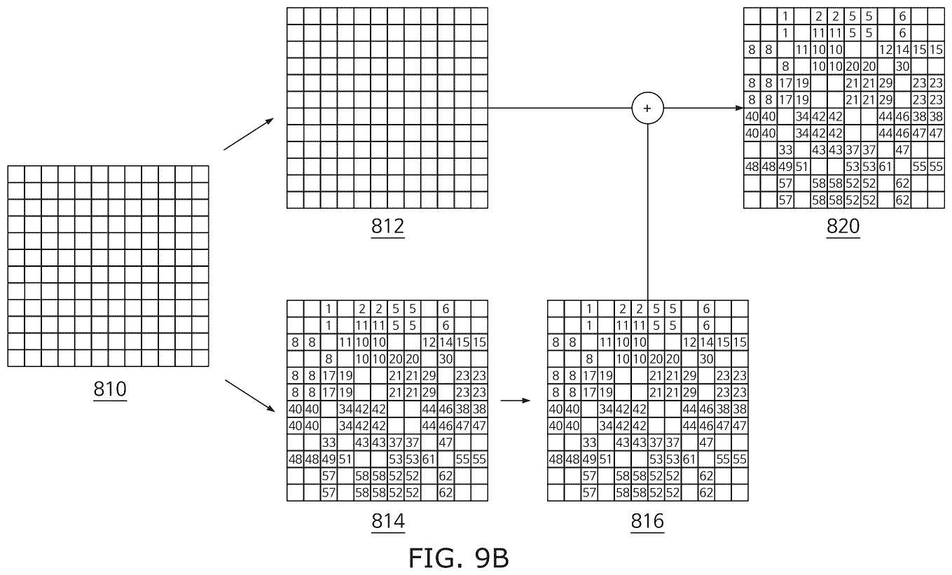

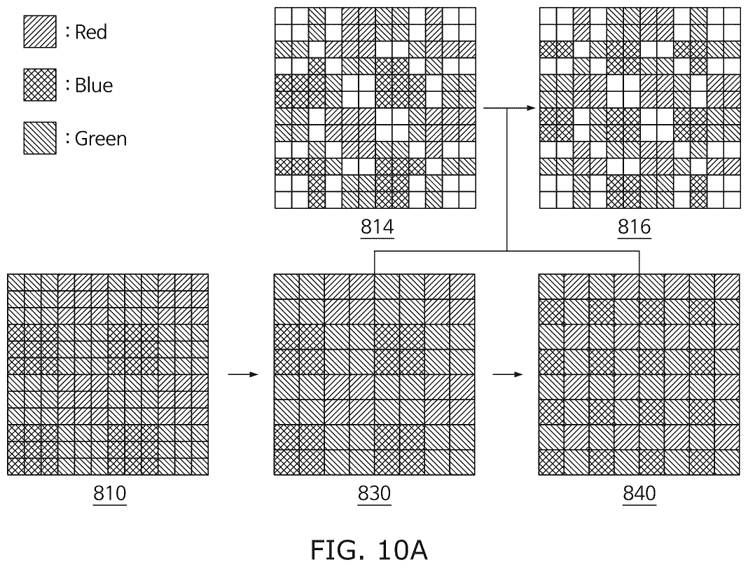

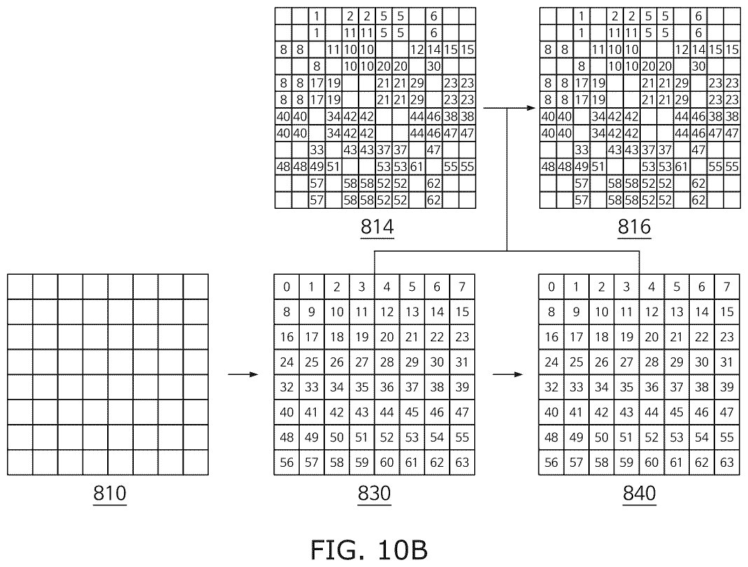

FIGS. 9A, 9B, 10A and 10B are diagrams illustrating a remosaic process in detail according to one or more example embodiments. For convenience of explanation, FIGS. 9A to 10B illustrate only a part of the image data that represents the color pattern. In addition, FIGS. 9A and 10A show color shading, and in FIGS. 9B and 10B, the numbers shown in the pixels are provided in order to represent the corresponding pixels between each image data during the remosaic process for convenience of explanation (i.e., the numbers do not represent the pixel value). That is, pixels having the same number in each image data may be regarded as the pixels corresponding to each other in the remosaic process.

The first image data 810 may be divided into first sub-image data 812 including a first set of pixel values and second sub-image data 814 including a second set of pixel values. The first sub-image data 812 and the second sub-image data 814 may be processed separately. On the other hand, the first sub-image data 812 and the second sub-image data 814 are only illustrated to be divided from each other for convenience of explanation, and may be processed as only the first image data 810 without being divided from each other.

The second image data 820 may be generated by retaining the pixel values of the first sub-image data 812 and changing the pixel values of the second sub-image data 814. That is, the second image data 820 may be generated by merging the first sub-image data 812 with third sub-image data 816 generated by changing pixel values of the second sub-image data 814.

In order to change the pixel values of the second sub-image data 814, the first image data 810 may be processed with binning (e.g., 1.5 binning) to generate reference image data 830. Referring to FIGS. 10A and 10B, the first image data 810 may include a color pattern of size 3×3, and the reference image data 830 may include a color pattern of size 2×2. That is, if the first image data 810 includes a color pattern of size k×l (where k and l are 3 or more and multiples of 3), the color pattern of the reference image data 830 may be a pattern of size 2k/3×2l/3.

Target image data 840 may be generated as a result of remosaicing the reference image data 830. For example, referring to FIGS. 10A and 10B, the target image data 840 may include a Bayer pattern.

The pixel values of the second sub-image data 814 may be changed into the pixel values of the third sub-image data 816 based on the corresponding reference pixel values included in the reference image data 830 and the corresponding target pixel values included in the target image data 840.

In one or more embodiments, the pixel values of the second sub-image data 814 may be changed into the pixel values of the third sub-image data 816 based on a ratio of the target pixel value to the reference pixel value assigned the same number as the pixel value of the second sub-image data 814.

Additionally or alternatively, the pixel values of the second sub-image data 814 may be changed into the pixel values of the third sub-image data 816 based on an offset between the target pixel value and the reference pixel value assigned the same number as the pixel value of the second sub-image data 814.

In one or more embodiments, the pixel values of the second sub-image data 814 may be changed into the pixel values of the third sub-image data 816 based on a weighted sum of the ratio of the target pixel value to the reference pixel value assigned the same number as the pixel value of the second sub-image data 814, and the offset between the reference pixel value and the target pixel value.

In other words, the pixel values of the second sub-image data 814 may be changed into the pixel values of the third sub-image data 816 based on Equation (1) described above, where PV4 may represent the pixel values of the third sub-image data 816, PV3 may represent the target pixel value, PV2 may represent the reference pixel value, PV1 may represent the pixel values of the second sub-image data 814, and each pixel value may be the pixel value assigned the same number in FIG. 10B.

FIG. 11 is a diagram illustrating an example of remosaicing image data including a pattern of size 2×2 according to one or more embodiments. First image data 1110 to be remosaiced may correspond to the second image data 420 of FIG. 4, and second image data 1120 may correspond to the third image data 430 of FIG. 4. Unlike the remosaic operation illustrated and described with reference to FIGS. 5 to 10, which may be performed by the image sensor, the remosaic operation of FIG. 11 may be performed by an application processor (or, ISP) external to the image sensor.

As illustrated in FIG. 11, the first image data 1110 may include a first color pattern of size 2×2. Remosaicing the first image data 1110 may result in generation of the second image data 1120 including a Bayer pattern.

An image generated by demosaicing the second image data 1120 may be output through a display (or, a user interface).

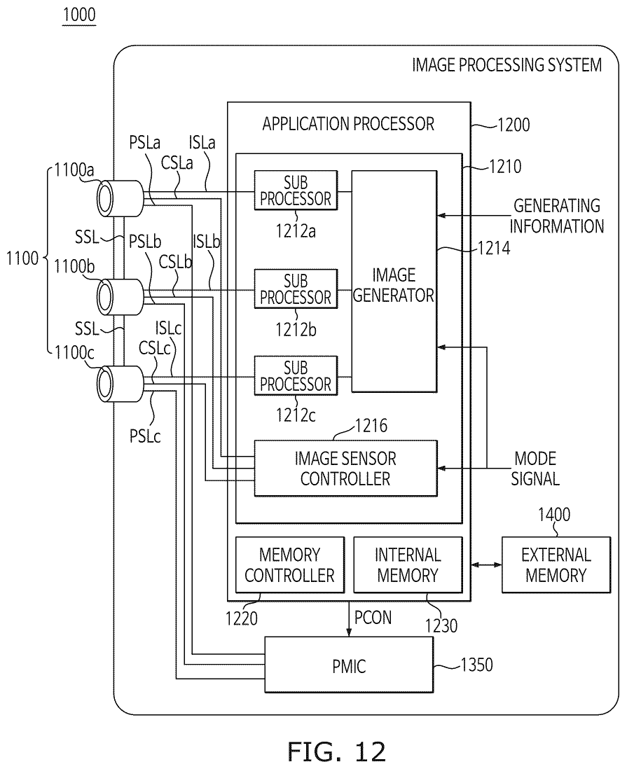

FIG. 12 is a block diagram of an image processing system including an image sensor according to one or more embodiments.

Referring to FIG. 12, an image processing system 1000 may include an image sensor group 1100, an application processor 1200, a power management integrated circuit (PMIC) 1350, and an external memory 1400. The image processing system 1000 may correspond to the image processing system 10 of FIG. 1.

The image sensor group 1100 may include a plurality of image sensors 1100a, 1100b, and 1100c. Although it is illustrated in the drawing that three image sensors 1100a, 1100b, and 1100c are arranged, embodiments are not limited thereto. In one or more embodiments, the image sensor group 1100 may be modified and implemented to include only two image sensors. In addition, in one or more embodiments, the image sensor group 1100 may also be modified and implemented to include n number of image sensors (n is a natural number equal to or greater than 4).

Each of the plurality of image sensors 1100a, 1100b, and 1100c may perform the remosaic operation on the image data according to one or more embodiments. For example, each of the plurality of image sensors 1100a, 1100b, and 1100c or the image sensor group 1100 may correspond to the image sensor 100 of FIG. 1, and perform the remosaic operation illustrated and described with reference to FIGS. 5 to 10.

In one or more embodiments, at least two image sensors (e.g., 1100a, 1100b) of the plurality of image sensors 1100a, 1100b, and 1100c may have different field of views from each other. In this case, for example, at least two image sensors (e.g., 1100a, 1100b) of the plurality of image sensors 1100a, 1100b, and 1100c may have different optical lenses from each other, but embodiments are not limited thereto.

In addition, in one or more embodiments, field of views of each of the plurality of image sensors 1100a, 1100b, and 1100c may be different from each other. In this case, the optical lenses included in each of the plurality of image sensors 1100a, 1100b, and 1100c may also be different from each other, but embodiments are not limited thereto.

In one or more embodiments, each of the plurality of image sensors 1100a, 1100b, and 1100c may be arranged to be physically separated from each other. That is, each of the plurality of image sensors 1100a, 1100b, and 1100c may have independent image sensor 1142 disposed therein, instead of dividing and using the sensing area of one image sensor 1142.

The application processor 1200 may include an image processing device 1210, a memory controller 1220, and an internal memory 1230. The application processor 1200 may correspond to the application processor 210 of FIGS. 1 to 4. The application processor 1200 may be implemented to be separated from the plurality of image sensors 1100a, 1100b, and 1100c. For example, the application processor 1200 and the plurality of image sensors 1100a, 1100b, and 1100c may be implemented and separated into separate semiconductor chips.

The image processing device 1210 may include a plurality of sub-image processors 1212a, 1212b, and 1212c, an image generator 1214, and an image sensor controller 1216.

The image processing device 1210 may include a plurality of sub-image processors 1212a, 1212b, and 1212c, which may correspond in number to the plurality of image sensors 1100a, 1100b, and 1100c.

The image data generated from each of the image sensors 1100a, 1100b, and 1100c may be provided to the corresponding sub-image processors 1212a, 1212b, and 1212c through image signal lines ISLa, ISLb, and ISLc which are separated from each other. For example, the image data generated from the image sensor 1100a may be provided to the sub-image processor 1212a through the image signal line ISLa, the image data generated from the image sensor 1100b may be provided to the sub-image processor 1212b through the image signal line ISLb, and the image data generated from the image sensor 1100c may be provided to the sub-image processor 1212c through the image signal line ISLc. For example, such image data transmission may be performed using a camera serial interface (CSI) based on the mobile industry processor interface (MIPI), but embodiments are not limited thereto.

Each of the sub-image processors 1212a, 1212b, and 1212c may perform the remosaic operation on the image data generated from each of the image sensors 1100a, 1100b, and 1100c. For example, each of the sub-image processors 1212a, 1212b, and 1212c may perform the remosaic operation illustrated and described with reference to FIG. 11. That is, since the remosaic operation may be divided and performed in steps in the image sensors 1100a, 1100b, and 1100c and the sub-image processors 1212a, 1212b, and 1212c, resources used for the remosaic operation in the image sensors 1100a, 1100b, and 1100c may be reduced, and image processing may be efficiently performed.

In one or more embodiments, one sub-image processor may be disposed to correspond to a plurality of image sensors. For example, the sub-image processor 1212a and the sub-image processor 1212c may be implemented to be integrated into one sub-image processor rather than being implemented separately from each other as illustrated, and the image data provided from the image sensor 1100a and the image sensor 1100c may be selected through a selection element (e.g., multiplexer), etc., and provided to the integrated sub-image processor.

The image data output from each of the sub-image processors 1212a, 1212b, and 1212c may be provided to the image generator 1214. The image generator 1214 may generate an output image using the image data provided from each of the sub-image processors 1212a, 1212b, and 1212c according to image generating information or mode signal.

Specifically, the image generator 1214 may merge at least a part of the image data generated from the image sensors 1100a, 1100b, and 1100c having different field of views from each other according to the image generating information or mode signal to generate an output image. In addition, the image generator 1214 may select any one from among the image data generated from the image sensors 1100a, 1100b, and 1100c having different field of views from each other according to the image generating information or mode signal to generate an output image.

The image generator 1214 may demosaic the image data provided from the sub-image processors 1212a, 1212b, and 1212c to generate an output image. The demosaiced image may be output through a user interface of the image processing system 1000.

The image sensor controller 1216 may provide a control signal to each of the image sensors 1100a, 1100b, and 1100c. The control signal generated from the image sensor controller 1216 may be provided to the corresponding image sensors 1100a, 1100b, and 1100c through the control signal lines CSLa, CSLb, and CSLc which are separated from each other.

The application processor 1200 may store the received image signal (that is, the encoded image signal or image data) in a memory 1230 provided therein and/or in a storage 1400 external to the application processor 1200. The application processor 1200 may read the encoded image signal from the memory 1230 or the storage 1400, decode the same, and display the image data generated based on the decoded image signal. For example, one or more of the plurality of sub-image processors 1212a, 1212b, and 1212c of the image processing device 1210 may perform decoding, and may also perform image processing on the decoded image signal.

The PMIC 1350 may supply power such as a power voltage to each of the plurality of image sensors 1100a, 1100b, and 1100c. For example, the PMIC 1350 may supply a first power to the image sensor 1100a through the power signal line PSLa, a second power to the image sensor 1100b through the power signal line PSLb, and a third power to the image sensor 1100c through the power signal line PSLc, under the control of the application processor 1200. In response to the power control signal PCON from the application processor 1200, the PMIC 1350 may generate power corresponding to each of the plurality of image sensors 1100a, 1100b, and 1100c, and may also adjust a level of power.

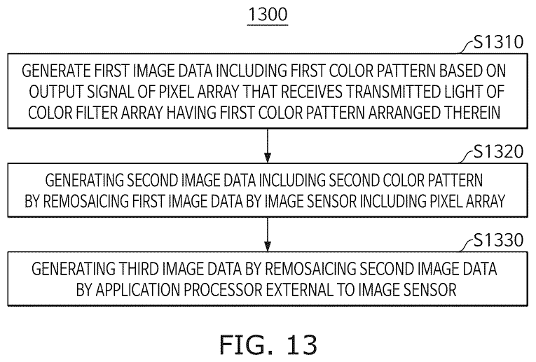

FIG. 13 is a flowchart illustrating an image processing method 1300 according to one or more embodiments. The method 1300 may be performed by an image processing system (e.g., the image processing system 1000 of FIG. 12). Specifically, the method 1300 may be performed by an image sensor (e.g., the image sensor 1100a, 1100b, and 1100c of FIG. 12) and an application processor (e.g., the application processor 1200 of FIG. 12) in the image processing system.

The method 1300 may be initiated by the image sensor generating first image data including a first color pattern based on an output signal of a pixel array that receives transmitted light through a color filter array with a first color pattern arranged therein, in operation S1310. In this case, the first color pattern may be a color pattern of size k×l, and k and l may be natural numbers of 3 or more.

The image sensor may remosaic the first image data to generate second image data including a second color pattern, in operation S1320. In this case, the second color pattern may be a color pattern of size p×q, and p and q may be natural numbers of 2 or more. The image sensor may bin the first image data to generate reference image data, remosaic the reference image data to generate target image data, and change pixel values included in the first image data based on the reference image data and the target image data to generate second image data. For example, the image sensor may change the pixel value included in the first image data based on a reference pixel value included in the reference image data and a target pixel value included in the target image data. The reference pixel value and the target pixel value may be pixel values corresponding to the pixel values included in the first image data.

The application processor may remosaic the second image data to generate third image data, in operation S1330. The third image data may be demosaiced to generate an image, and the generated image may be output through a user interface.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like (collectively “devices”) represented by a block or an equivalent indication in the above embodiments may be physically implemented by analog and/or digital circuits including one or more of a logic gate, an integrated circuit, a microprocessor, a microcontroller such as a central processing unit (CPU), a memory circuit, a passive electronic component, an active electronic component, an optical component, and the like, and the functions or operations of the devices may be implemented by or driven by software and/or firmware executed by the devices.

According to one or more example embodiments, a plurality of the remosaic operations for image data may be distributed and performed in each of the image sensor and the application processor external to the image sensor, which may reduce resources used in the remosaic operations in the image sensor and enable efficient image processing.

According to one or more example embodiments, since the image signal processor or the image sensor may not need to be equipped with all logics corresponding to various types of remosaic operations, the detailed structure of the image signal processor or the image sensor may be simplified.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

1. An image sensor, comprising:
a pixel array comprising a plurality of unit pixels configured to receive light of a color filter array having a first color pattern of size k×l arranged therein, wherein k and l are natural numbers of 3 or more, the image sensor configured to generate first image data comprising the first color pattern; and
an image signal processor (ISP) configured to generate second image data comprising a second color pattern of size p×q, by remosaicing the first image data, wherein p and q are natural numbers of 2 or more,
wherein a size of the second color pattern is smaller than a size of the first color pattern, and
wherein the image sensor is configured to transmit the second image data an application processor that is external to the image sensor.

2. The image sensor according to claim 1, wherein the second color pattern is of size 2×2.

3. The image sensor according to claim 1, wherein the plurality of unit pixels comprise a first group of unit pixels and a second group of unit pixels, the second group of unit pixels comprising the remaining unit pixels of the plurality of unit pixels that are not in the first group of unit pixels,
wherein the first image data comprises:
a first set of pixel values comprising pixel values read from the first group of unit pixels; and
a second set of pixel values comprising pixel values read from the second group of unit pixels, and
wherein the ISP is further configured to generate the second image data by retaining pixel values of the first set of pixel values and changing pixel values of the second set of pixel values.

4. The image sensor according to claim 3, wherein a color in the first color pattern corresponding to the first group of unit pixels is the same as a color in the second color pattern corresponding to the first group of unit pixels.

5. The image sensor according to claim 3, wherein a color in the first color pattern corresponding to the second group of unit pixels is different from a color in the second color pattern corresponding to the second group of unit pixels.

6. The image sensor according to claim 3, wherein the ISP is configured to:
generate reference image data by binning the first image data;
generate target image data by remosaicing the reference image data; and
change a pixel value in the second set of pixel values based on a reference pixel value in the reference image data that is associated with the second group of unit pixels
and a target pixel value in the target image data that is associated with the second group of unit pixels.

7. The image sensor according to claim 6, wherein the ISP is configured to change the pixel value in the second set of pixel values based on a ratio of the target pixel value to the reference pixel value.

8. The image sensor according to claim 6, wherein the ISP is configured to change the pixel value in the second set of pixel values based on an offset between the reference pixel value and the target pixel value.

9. The image sensor according to claim 6, wherein the ISP is configured to change the pixel value in the second set of pixel values based on a weighted sum of a ratio of the target pixel value to the reference pixel value and an offset between the reference pixel value and the target pixel value.

10. The image sensor according to claim 6, wherein a color pattern of the reference image data is of size k/2×l/2, and
wherein k and l are even numbers.

11. The image sensor according to claim 6, wherein a color pattern of the reference image data is of size 2k/3×l/3, and
wherein k and l are multiples of 3.

12. The image sensor according to claim 1, wherein the first color pattern is of size 4×4, and
wherein the second color pattern is of size 2×2.

13. The image sensor according to claim 1, wherein the first color pattern is a size 3×3, and
wherein the second color pattern is a pattern of size 2×2.

14. The image sensor according to claim 1, wherein the first image data comprises phase data associated with a phase difference according to positions of the light on the pixel array, and
wherein the ISP is further configured to:
remove the phase data from the first image data; and
remosaic the first image data from which the phase data has been removed.

15. An image processing system, comprising:
an image sensor comprising:
a pixel array comprising a plurality of unit pixels configured to receive light of a color filter array having a first color pattern of size k×l arranged therein, wherein k and l are natural numbers of 3 or more, the image sensor configured to generate first image data comprising the first color pattern; and
an image signal processor (ISP) configured to generate second image data comprising a second color pattern of size p×q, by remosaicing the first image data, wherein p and q are natural numbers of 2 or more; and
an image processing device external to the image sensor and configured to generate third image data by remosaicing the second image data.

16. The image processing system according to claim 15, wherein the image processing system further comprises a display configured to output a user interface, and
wherein the user interface is configured to output a demosaiced image based on the third image data.

17. The image processing system according to claim 15, wherein the first color pattern is of size 4×4,
wherein the second color pattern is of size 2×2, and
wherein the third image data comprises a single Bayer pattern.

18. An image processing method, comprising:
generating, by an image sensor, first image data comprising a first color pattern, based on an output signal of a pixel array configured to receive light of a color filter array having the first color pattern of size k×l arranged therein, wherein k and l are natural numbers of 3 or more;
generating, by the image sensor, second image data comprising a second color pattern of size p×q by remosaicing the first image data, wherein p and q are natural numbers of 2 or more; and
generating, by an application processor that is external to the image sensor, third image data by remosaicing the second image data.

19. The image processing method according to claim 18, wherein the generating the second image data comprises:
generating reference image data by binning the first image data;
generating target image data by remosaicing the reference image data; and
changing, based on the reference image data and the target image data, pixel values in the first image data.

20. The image processing method according to claim 19, wherein the changing the pixel values in the first image data comprises changing a pixel value in the first image data based on a reference pixel value in the reference image data and a target pixel value in the target image data, and
wherein the reference pixel value and the target pixel value correspond to the pixel values in the first image data.
